(19) United States
(12) Patent Application Publication
(10) Pub. No.: US 2026/0326445 A1
(43) Pub. Date: Oct. 22, 2026

(54) LIQUID EJECTING APPARATUS AND INK-JET RECORDING APPARATUS

(71) Applicant: KYOCERA Document Solutions Inc., Osaka (JP)

(72) Inventors: Shogo Yoneda, Osaka (JP); Kenichi Satake, Osaka (JP); Hideki Ishida, Osaka (JP); Nanako Nishida, Osaka (JP); Koichi Imanaka, Osaka (JP); Shun Tsuboi, Osaka (JP)

(21) Appl. No.: 19/646,776

(22) Filed: Apr. 14, 2026

(30) Foreign Application Priority Data
Apr. 17, 2025 (JP) 2025-067921

(51) Int. Cl. B41J 2/165; B41J 2/175

(52) U.S. Cl. CPC B41J 2/16523; B41J 2/16532; B41J 2/17596; B41J 2002/16594

(57) ABSTRACT

A liquid expelling apparatus is capable of performing a liquid expelling process to expel liquid from a liquid ejecting head through a cap covering a plurality of nozzles of the liquid ejecting head by sucking in air from the cap. A control apparatus causes the liquid ejecting head to perform a liquid ejecting process according to occurrence of a liquid expelling event and causes the liquid expelling apparatus to perform the liquid expelling process, concurrently with start of the liquid ejecting process or following the start of the liquid ejecting process.

### INCORPORATION BY REFERENCE

This application is based upon and claims the benefit of priority from the corresponding Japanese Patent Application No. 2025-067921 filed on Apr. 17, 2025, the entire contents of which are incorporated herein by reference.

### BACKGROUND

The present disclosure relates to a liquid ejecting apparatus and an ink-jet recording apparatus that include a liquid expelling apparatus to expel liquid in a liquid ejecting head by sucking in air from a cap that covers a plurality of nozzles.

The ink-jet recording apparatus includes an ink ejecting apparatus that ejects ink drops from an ink-jet head onto a sheet to form an image on the sheet. The ink ejecting apparatus is an example of a liquid ejecting apparatus that ejects liquid drops. The ink-jet head is an example of a liquid ejecting head.

When air bubbles form in the ink-jet head in the ink-jet recording apparatus, a failure in ejecting ink occurs easily. The ink ejecting apparatus may include an ink expelling apparatus in order to expel the air bubbles from the ink-jet head along with ink.

The ink expelling apparatus sucks in air from a cap covering a plurality of nozzles in the ink-jet head. Accordingly, the ink in the ink-jet head is expelled along with the air bubbles, and new ink that contains no air bubbles is supplied into the ink-jet head through an ink supply path. The ink expelling apparatus is an example of the liquid expelling apparatus.

For example, it is known that in the ink ejecting apparatus a pressure applying mechanism applies pressure to an ink supply path after the ink expelling apparatus is operated.

### SUMMARY

A liquid ejecting apparatus according to an aspect of the present disclosure includes a liquid storage, a liquid ejecting head, a pressure-regulating-valve apparatus, a liquid expelling apparatus, and a control apparatus. The liquid storage stores therein liquid. The liquid ejecting head includes a plurality of nozzles, is supplied with the liquid from the liquid storage through a supply path, and is capable of performing a liquid ejecting process to eject liquid drops from each of the plurality of nozzles. The pressure-regulating-valve apparatus includes a valve capable of shutting off the supply path and temporarily switches from a certain state to another state according to a change in pressure caused in the supply path due to the liquid drops being ejected by the liquid ejecting head, the certain state being a state in which the supply path is shut off using the valve, the other state being a state in which the shutoff of the supply path using the valve is canceled. The liquid expelling apparatus includes a cap capable of covering the plurality of nozzles, and is capable of performing a liquid expelling process to expel the liquid from the liquid ejecting head through the cap by sucking in air from the cap covering the plurality of nozzles. The control apparatus causes the liquid ejecting head to perform the liquid ejecting process according to occurrence of a liquid expelling event and causes the liquid expelling apparatus to perform the liquid expelling process, concurrently with start of the liquid ejecting process or following the start of the liquid ejecting process.

An ink-jet recording apparatus according to another aspect of the present disclosure includes a sheet transportation apparatus that transports a sheet, and the liquid ejecting apparatus ejecting ink drops onto the transported sheet to form an image on the sheet.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a view illustrating a configuration of an ink-jet recording apparatus according to an embodiment;

FIG. 2 is a view illustrating the ink-jet recording apparatus at the time of performing an ink expelling process;

FIG. 3 is a block diagram illustrating a configuration of a control apparatus included in the ink-jet recording apparatus according to the embodiment;

FIG. 4 is a view illustrating configurations of an ink supplying apparatus, an ink-jet head, and an ink expelling apparatus that are included in the ink-jet recording apparatus according to the embodiment;

FIG. 5 is a cross-sectional view of a pressure-regulating-valve apparatus in a closed state in the ink-jet recording apparatus according to the embodiment;

FIG. 6 is a cross-sectional view of the pressure-regulating-valve apparatus in an open state in the ink-jet recording apparatus according to the embodiment;

FIG. 7 is a timing chart showing a relationship between operations of a suction pump and a control valve and pressure in a head; and

FIG. 8 is a timing chart showing a relationship between operations of the suction pump, the ink-jet head, and the control valve and the pressure in a head.

### DETAILED DESCRIPTION

Hereinafter, an embodiment of the present disclosure will be described with reference to the drawings. Note that the following embodiment is an example embodying the present disclosure and is not intended to limit the technical scope of the present disclosure.

### Configuration of Ink-Jet Recording Apparatus 10

An ink-jet recording apparatus 10 according to an embodiment is an image forming apparatus that can perform a printing process by ink-jetting. The printing process is a process of forming an image on a sheet 9. The sheet 9 is an image formation medium in the form of a sheet, such as paper or a resin film.

Note that the ink-jet recording apparatus 10 may be a facsimile apparatus, copying machine, or multifunctional device that can perform the printing process by ink-jetting.

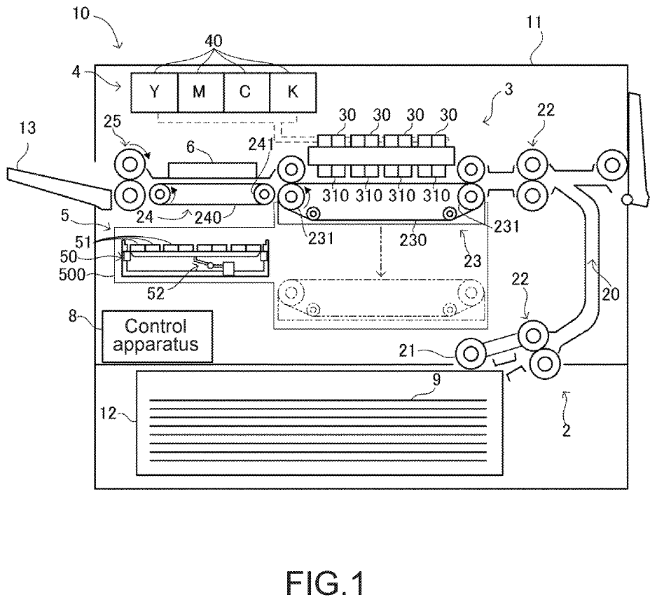

As illustrated in FIG. 1, the ink-jet recording apparatus 10 includes, for example, a sheet accommodating portion 12, a sheet transportation apparatus 2, an ink ejecting apparatus 3, a drying apparatus 6, and a control apparatus 8. The sheet transportation apparatus 2, the ink ejecting apparatus 3, the drying apparatus 6, and the control apparatus 8 are accommodated in a housing 11 that is a main body.

The ink ejecting apparatus 3 includes an ink supplying apparatus 4, a plurality of ink-jet heads 30, and an ink expelling apparatus 5. The ink supplying apparatus 4 supplies inks to the plurality of ink-jet heads 30.

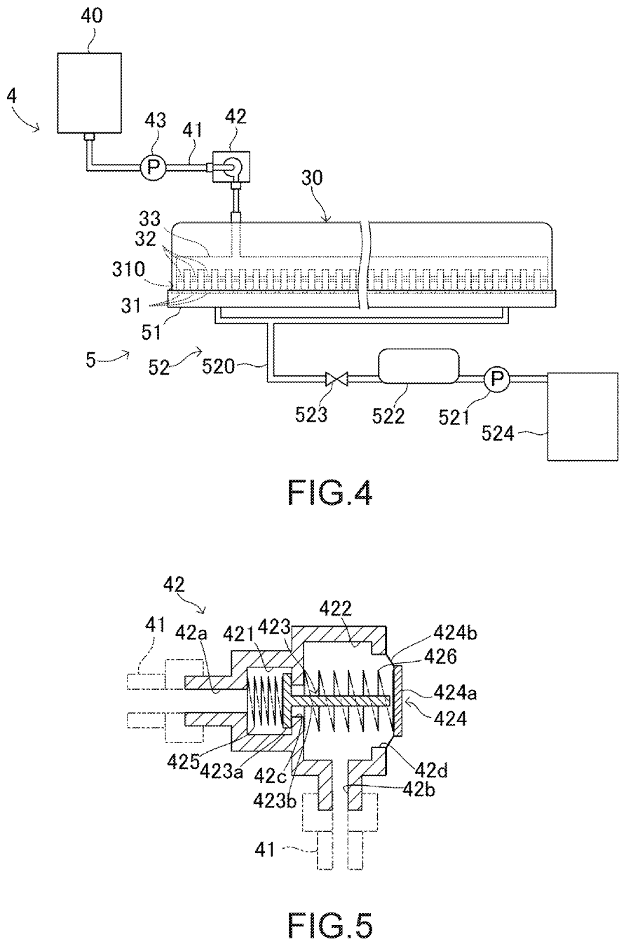

Each ink-jet head 30 includes a nozzle group 310 including a plurality of nozzles 31 (refer to FIGS. 1 and 4). Each of the plurality of nozzles 31 ejects ink drops. The ink expelling apparatus 5 performs an ink expelling process to expel inks from the plurality of ink-jet heads 30.

The sheet accommodating portion 12 can accommodate therein a plurality of sheets 9. The sheet transportation apparatus 2 transports, along a sheet transportation path 20, each sheet 9 accommodated in the sheet accommodating portion 12, and discharges the sheet 9 into a discharge tray 13 from the sheet transportation path 20.

The sheet transportation apparatus 2 includes, for example, a sheet feeding mechanism 21, a plurality of transportation roller pairs 22, a primary transportation unit 23, an output-side transportation unit 24, and a discharge roller pair 25. The sheet feeding mechanism 21 feeds each sheet 9 to the sheet transportation path 20 from the sheet accommodating portion 12.

The plurality of transportation roller pairs 22 takes over the transportation of the sheet 9 from the sheet feeding mechanism 21, and transports the sheet 9 toward the primary transportation unit 23.

The primary transportation unit 23 is arranged below the plurality of ink-jet heads 30. The primary transportation unit 23 transports each sheet 9 along the nozzle groups 310 of the plurality of ink-jet heads 30.

In the primary transportation unit 23, a plurality of suspension rollers 231 supports and rotates an endless primary transportation belt 230. This causes the primary transportation unit 23 to transport each sheet 9 on an upper surface of the primary transportation belt 230, and further feeds the sheet 9 to the output-side transportation unit 24. A portion between the upper surface of the primary transportation belt 230 and the plurality of ink-jet heads 30 forms a portion of the sheet transportation path 20.

The output-side transportation unit 24 is arranged downstream of the primary transportation unit 23 in a sheet-transportation direction, where the primary transportation unit 23 is situated at a reference position.

In the output-side transportation unit 24, a plurality of suspension rollers 241 supports and rotates an endless output-side transportation belt 240. This causes the output-side transportation unit 24 to transport each sheet 9 on an upper surface of the output-side transportation belt 240, and further feeds the sheet 9 to the discharge roller pair 25, where an image is formed on the sheet 9.

The drying apparatus 6 blows heated air to each sheet 9 transported by the output-side transportation unit 24, such that ink on the sheet 9 is dried. The discharge roller pair 25 discharges, into the discharge tray 13, each sheet 9 on which an image is formed.

The ink supplying apparatus 4 includes a plurality of ink containers 40 each storing therein ink. Each ink container 40 is an example of a liquid storage that stores therein liquid. The ink is an example of liquid.

The ink supplying apparatus 4 supplies ink to each of the plurality of ink-jet heads 30 from a corresponding one of the plurality of ink containers 40. The ink containers 40 of the plurality of ink containers 40 respectively store therein inks of different colors. The ink-jet heads 30 of the plurality of ink-jet heads 30 respectively eject inks of different colors. In the present embodiment, examples of the color of the ink include four colors that are black, cyan, magenta, and yellow.

Each ink-jet head 30 performs an ink ejecting process to eject ink drops from each of the plurality of nozzles 31. The plurality of ink-jet heads 30 ejects ink drops onto each sheet 9 transported by the primary transportation unit 23, such that an image is formed on the sheet 9.

The ink ejecting process is an example of a liquid ejecting process to eject liquid drops. Each ink-jet head 30 is an example of a liquid ejecting head that performs the liquid ejecting process. The ink ejecting apparatus 3 is an example of a liquid ejecting apparatus that ejects liquid drops onto each transported sheet 9 to form an image on the sheet 9.

The ink expelling process is an example of a liquid expelling process to expel liquid from the liquid ejecting head. The ink expelling apparatus 5 is an example of a liquid expelling apparatus that performs the liquid expelling process.

Each ink-jet head 30 includes an introduction path 33 that communicates with the plurality of nozzles 31 (refer to FIG. 4). Ink supplied by the ink supplying apparatus 4 is supplied to the plurality of nozzles 31 through the introduction path 33.

Each ink-jet head 30 further includes a plurality of piezoelectric elements 32 each corresponding to a corresponding one of the plurality of nozzles 31 (refer to FIG. 4). Each piezoelectric element 32 vibrates by being supplied with an ejection drive signal by the control apparatus 8, to thereby apply pressure to ink and jet the ink from a corresponding one of the nozzles 31.

When air bubbles form in each ink-jet head 30 in the ink ejecting apparatus 3, a failure in ejecting ink occurs easily. The ink ejecting apparatus 3 includes the ink expelling apparatus 5 in order to expel the air bubbles from each ink-jet head 30 along with ink.

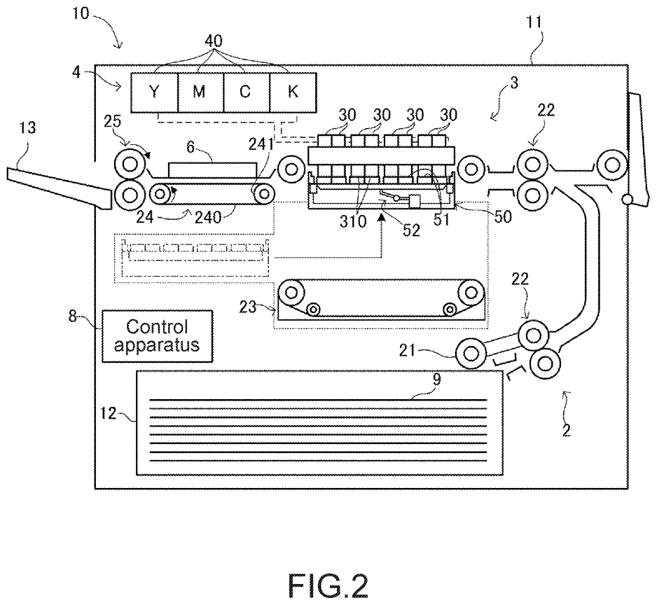

The ink expelling apparatus 5 includes a cap 51 that can cover the nozzle group 310 of each of the plurality of ink-jet heads 30 (refer to FIGS. 2 and 4). Further, the ink expelling apparatus 5 includes a suction apparatus 52 that sucks in air from the cap 51 covering the nozzle group 310 (refer to FIGS. 2 and 4). The ink expelling process is a process of expelling ink from each of the plurality of ink-jet heads 30 through the cap 51 by air being sucked in from the cap 51.

The ink expelling process is performed to expel the air bubbles from each ink-jet head 30 along with ink. Further, concurrently with expelling of ink from each ink-jet head 30, new ink is supplied to the ink-jet head 30 by the ink supplying apparatus 4.

When the printing process is performed, the primary transportation unit 23 is supported at the reference position enabling the sheet transportation path 20 to be formed between the primary transportation unit 23 and the plurality of ink-jet heads 30. FIG. 1 illustrates the primary transportation unit 23 situated at the reference position.

The primary transportation unit 23 is supported movably to a transportation retraction position that is more distant from the plurality of ink-jet heads 30 than the reference position. FIG. 2 illustrates the primary transportation unit 23 situated at the transportation retraction position. In the present embodiment, the transportation retraction position is a position situated vertically below the reference position.

The ink expelling apparatus 5 includes a cap unit 50 that includes the caps 51 and a portion of or all of the suction apparatus 52, and a unit moving apparatus 500 that moves the cap unit 50 and the primary transportation unit 23 (refer to FIGS. 1 and 2).

The cap unit 50 is supported movably between a cap retraction position and a cap position. FIG. 1 illustrates the cap unit 50 situated at the cap retraction position. FIG. 2 illustrates the cap unit 50 situated at the cap position.

The cap retraction position is a position at which the cap unit 50 does not interfere with the primary transportation unit 23 situated at the reference position. The cap position is a position of the cap unit 50 when the cap 51 covers the nozzle group 310 of each of the plurality of ink-jet heads 30.

The unit moving apparatus 500 moves the primary transportation unit 23 from the reference position to the transportation retraction position and further moves the cap unit 50 from the cap retraction position to the cap position according to first movement control by the control apparatus 8 (refer to FIG. 2).

The unit moving apparatus 500 further moves the cap unit 50 from the cap position to the cap retraction position and further moves the primary transportation unit 23 from the transportation retraction position to the reference position according to second movement control by the control apparatus 8 (refer to FIG. 1).

In the present embodiment, the suction apparatus 52 includes an expelling path 520, a suction pump 521, a buffer tank 522, a control valve 523, and a collection tank 524 (refer to FIG. 4).

The expelling path 520 is a tube that communicates with an interior of the cap 51, and with the suction pump 521 and the collection tank 524. For example, the expelling path 520 may be a pipe, a hose, or a combination of a pipe and a hose.

The suction pump 521 is arranged in the expelling path 520 between the cap 51 and the collection tank 524. In the present embodiment, the suction pump 521 is a tube pump. Accordingly, when the suction pump 521 is stopped, shutoff is performed in a portion in which the suction pump 521 is arranged in the expelling path 520. Note that the same applies to the case in which a diaphragm pump is adopted as the suction pump 521.

The buffer tank 522 is arranged in the expelling path 520 between the cap 51 and the suction pump 521. The buffer tank 522 temporarily stores therein air and ink that flow through the expelling path 520.

The control valve 523 is arranged in the expelling path 520 between the cap 51 and the buffer tank 522. The control valve 523 switches between an expelling-path closed state and an expelling-path open state according to an input control signal. The expelling-path closed state is a state in which the expelling path 520 is shut off. The expelling-path open state is a state in which the shutoff of the expelling path 520 is canceled.

The ink expelling apparatus 5 performs the ink expelling process by a warming-up movement and an expelling movement after the warming-up movement is performed. The warming-up movement is a movement to stop the suction pump 521 after the suction pump 521 operates for a specified period of time when the control valve 523 is in the expelling-path closed state. The expelling movement is a movement to switch the control valve 523 from the expelling-path closed state to the expelling-path open state.

Pressure in the buffer tank 522 is decreased by the ink expelling apparatus 5 performing the warming-up movement. Ink is sucked in from each ink-jet head 30 due to a negative pressure in the buffer tank 522 by the ink expelling apparatus 5 performing the expelling movement.

Ink is expelled from each ink-jet head 30 along with air bubbles by the suction apparatus 52 operating, and new ink that contains no air bubbles is supplied into the ink-jet head 30 by the ink supplying apparatus 4.

The control apparatus 8 controls the sheet transportation apparatus 2, the ink ejecting apparatus 3, and the drying apparatus 6.

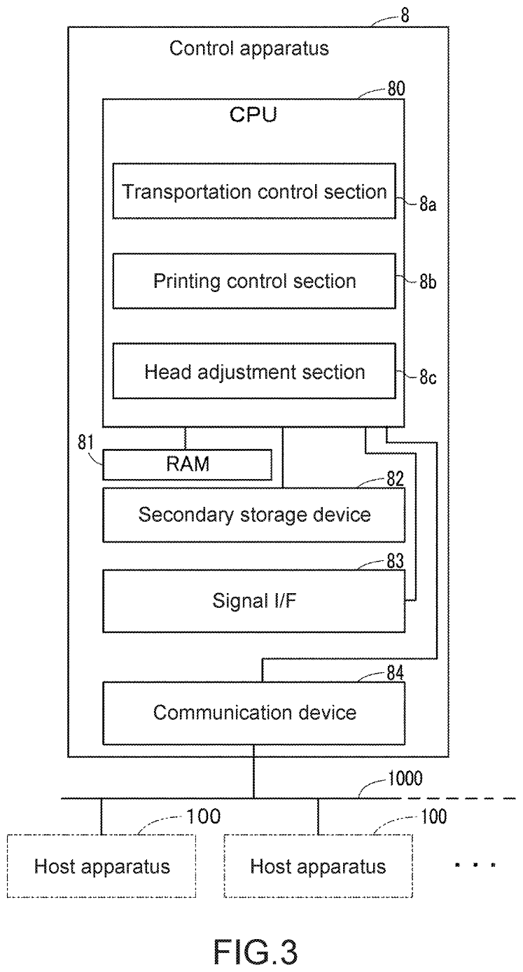

The control apparatus 8 includes, for example, a central processing unit (CPU) 80, a random access memory (RAM) 81, a secondary storage device 82, a signal interface 83, and a communication device 84 (refer to FIG. 3).

The CPU 80 executes a computer program to perform various types of control and data processes. The RAM 81 temporarily stores the computer program and various types of data executed by the CPU 80.

The secondary storage device 82 is a computer-readable, nonvolatile storage device. The secondary storage device 82 stores the computer program and various types of data executed by the CPU 80. For example, one or both of a flash memory and a hard disk drive are adopted as the secondary storage device 82.

The signal interface 83 converts detection signals of various sensors into digital detection data and transmits the detection data to the CPU 80. The signal interface 83 further converts a control command that is output from the CPU 80 into a control signal and transmits the control signal to a device to be controlled.

The communication device 84 performs communication with another apparatus such as a host apparatus 100 via a network 1000. The CPU 80 performs communication with another apparatus through the communication device 84. The host apparatus 100 is an information processing apparatus that requests the ink-jet recording apparatus 10 to perform the printing process described above.

The CPU 80 includes a plurality of processing modules implemented by executing the computer program. The plurality of processing modules includes, for example, a transportation control section 8a, a printing control section 8b, and a head adjustment section 8c (refer to FIG. 3).

The transportation control section 8a controls the sheet transportation apparatus 2 to control transportation of each sheet 9. In the present embodiment, the transportation control section 8a forms a portion of the sheet transportation apparatus 2.

The printing control section 8b causes the plurality of ink-jet heads 30 to perform the ink ejecting process in synchronization with the transportation of the sheet 9.

The head adjustment section 8c controls the ink expelling apparatus 5 to perform the ink expelling process. In the present embodiment, the printing control section 8b and the head adjustment section 8c form a portion of the ink ejecting apparatus 3.

Note that a portion or all of the processes executed by the CPU 80 may be executed by, for example, a digital signal processor (DSP) or a system on a chip (SoC). Each of the CPU 80, the DSP, and the SoC is an example of the processor.

By the way, the ink supplying apparatus 4 includes a supply path 41 and a pressure-regulating-valve apparatus 42 in the ink ejecting apparatus 3 (refer to FIG. 4). The pressure-regulating-valve apparatus 42 is arranged in the supply path 41 connected to each ink container 40 and to a corresponding one of the ink-jet heads 30.

The pressure-regulating-valve apparatus 42 temporarily switches from a supply-path closed state to a supply-path open state according to a change in pressure caused in the supply path 41 due to ink drops being ejected by each ink-jet head 30. The supply-path closed state is a state in which the supply path 41 is shut off using a valve 423 (refer to FIG. 5).

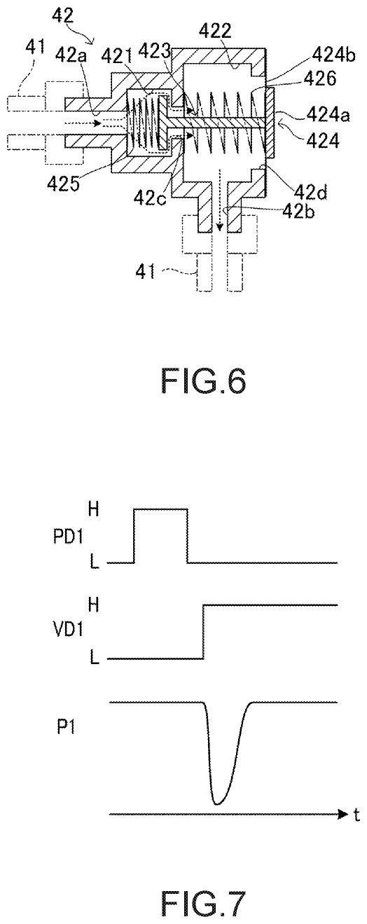

On the other hand, the supply-path open state is a state in which the shutoff of the supply path 41 using the valve 423 is canceled (refer to FIG. 6). When the pressure-regulating-valve apparatus 42 switches to the supply-path open state, ink is replenished in each ink-jet head 30 in response to ink drops being ejected by the ink-jet head 30 (refer to FIG. 6).

In other words, the valve 423 is a member that can shut off the supply path 41. When the pressure-regulating-valve apparatus 42 is in the supply-path open state, each ink-jet head 30 is supplied with ink from a corresponding one of the ink containers 40 through the supply path 41.

The ink supplying apparatus 4 further includes a pressurizing pump 43 that is arranged in the supply path 41 (refer to FIG. 4). The pressurizing pump 43 applies pressure to ink in the supply path 41. The printing control section 8b operates the pressurizing pump 43 when the printing process is performed. Note that the ink supplying apparatus 4 may include no pressurizing pump 43.

As illustrated in FIG. 5, the pressure-regulating-valve apparatus 42 includes a primary chamber 421, a secondary chamber 422, the valve 423, a cover member 424, a first spring 425, and a second spring 426. The cover member 424 includes a pressure receiving plate 424a and a diaphragm 424b.

The primary chamber 421 includes an inflow port 42a into which ink flows. A communication hole 42c is formed in a partition between the primary chamber 421 and the secondary chamber 422. In other words, the primary chamber 421 and the secondary chamber 422 communicate with each other by the communication hole 42c.

The secondary chamber 422 includes an outflow port 42b from which ink flows. The valve 423 is a member that can open and close the communication hole 42c.

The valve 423 includes a shielding portion 423a that closes the communication hole 42c, and an axial portion 423b that is arranged to pass through the communication hole 42c. The valve 423 can be moved between a closed position at which the communication hole 42c is closed with the shielding portion 423a, and an open position at which the communication hole 42c is open.

The shielding portion 423a is arranged in the primary chamber 421, and the axial portion 423b extends into the secondary chamber 422 from the shielding portion 423a. The secondary chamber 422 includes an opening 42d.

The cover member 424 covers the opening 42d of the secondary chamber 422. The pressure receiving plate 424a covers a portion of the opening 42d, and the diaphragm 424b covers a remaining portion of the opening 42d.

The diaphragm 424b is connected to the pressure receiving plate 424a and to an edge portion of the opening 42d of the secondary chamber 422. The diaphragm 424b is a member that can contract and expand.

The first spring 425 is arranged in the primary chamber 421, and the second spring 426 is arranged in the secondary chamber 422. The first spring 425 biases the shielding portion 423a to hold the valve 423 at the closed position.

The second spring 426 biases the pressure receiving plate 424a outward from the secondary chamber 422 to hold the pressure receiving plate 424a at a reference position. When each ink-jet head 30 performs the ink ejecting process, pressure in the secondary chamber 422 is decreased so that the diaphragm 424b contracts, and the pressure receiving plate 424a resists a biasing force of the second spring 426 to be moved inward of the secondary chamber 422 from the reference position (refer to FIG. 6).

When the pressure receiving plate 424a is moved inward of the secondary chamber 422, the pressure receiving plate 424a resists a biasing force of the first spring 425 to press the axial portion 423b of the valve 423 toward the primary chamber 421 (refer to FIG. 6). As a result, the valve 423 is moved from the closed position to the open position, and the pressure-regulating-valve apparatus 42 switches from the supply-path closed state to the supply-path open state.

In other words, the diaphragm 424b contracts and expands according to a change in pressure in the secondary chamber 422, and the valve 423 opens and closes the communication hole 42c according to the contraction and expansion of the diaphragm 424b.

When the pressure-regulating-valve apparatus 42 switches from the supply-path closed state to the supply-path open state, ink flows into the outflow port 42b from the inflow port 42a through the primary chamber 421, the communication hole 42c, and the secondary chamber 422 (refer to FIG. 6).

On the other hand, when each ink-jet head 30 stops performing the ink ejecting process, the pressure in the secondary chamber 422 is increased so that the diaphragm 424b expands, and the pressure receiving plate 424a returns to the reference position due to the biasing force of the second spring 426. As a result, the valve 423 is moved from the open position to the closed position, and the pressure-regulating-valve apparatus 42 switches from the supply-path open state to the supply-path closed state (refer to FIG. 5).

When the ink expelling apparatus 5 operates in the ink ejecting apparatus 3, pressure in each ink-jet head 30 is decreased suddenly. Accordingly, the pressure-regulating-valve apparatus 42 may be damaged.

FIG. 7 is a timing chart showing a relationship between a pump drive signal PD1, which is a drive signal input by the suction pump 521, a valve control signal VD1, which is a control signal input by the control valve 523, and a head pressure P1. The head pressure P1 is pressure in each ink-jet head 30.

In FIG. 7, a situation in which the pump drive signal PD1 is at a low level indicates that the suction pump 521 is stopped, and a situation in which the pump drive signal PD1 is at a high level indicates that the suction pump 521 is operating.

In FIG. 7, a situation in which the valve control signal VD1 is at a low level indicates that the control valve 523 is in the expelling-path closed state, and a situation in which the valve control signal VD1 is at a high level indicates that the control valve 523 is in the expelling-path open state.

In other words, the operation of the ink expelling apparatus 5 when the pump drive signal PD1 changes from a low level to a high level and the pump drive signal PD1 further changes from a high level to a low level under the situation in which the valve control signal VD1 is at a low level is the warming-up movement.

In addition, the operation of the ink expelling apparatus 5 when the valve control signal VD1 changes from a low level to a high level is the expelling movement.

As illustrated in FIG. 7, when the ink expelling apparatus 5 operates, the head pressure P1 is decreased suddenly. Accordingly, the pressure-regulating-valve apparatus 42 may be damaged. In the present embodiment, when the head pressure P1 is decreased suddenly, the diaphragm 424b of the pressure-regulating-valve apparatus 42 may be damaged.

In the ink ejecting apparatus 3, the control apparatus 8 performs a process for preventing the pressure-regulating-valve apparatus 42 from being damaged by the operation of the ink expelling apparatus 5.

In the present embodiment, the head adjustment section 8c controls the plurality of ink-jet heads 30 when causing the ink expelling apparatus 5 to perform the ink expelling process.

The head adjustment section 8c performs the first movement control and ink expelling control according to occurrence of a predetermined ink expelling event. For example, the ink expelling event is an event to input an ink expelling instruction through an operation apparatus not illustrated or through the communication device 84. The ink expelling event is an example of a liquid expelling event.

The head adjustment section 8c performs the first movement control and then performs the ink expelling control.

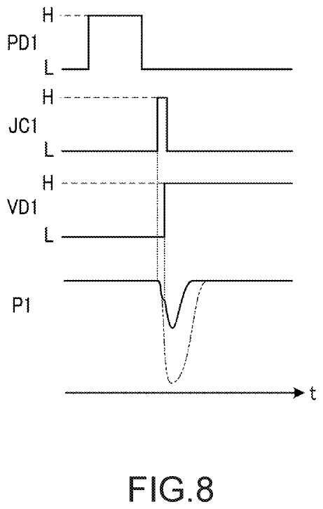

A timing chart in FIG. 8 illustrates a relationship between the operation of the suction pump 521, the plurality of ink-jet heads 30, and the control valve 523 and the head pressure P1 when the head adjustment section 8c performs the ink expelling control.

In the ink expelling control, the head adjustment section 8c operates the plurality of ink-jet heads 30 and also causes the ink expelling apparatus 5 to perform the ink expelling process.

Specifically, in the ink expelling control, the head adjustment section 8c causes the ink expelling apparatus 5 to perform the warming-up movement. In FIG. 8, the period in which the pump drive signal PD1 is at a high level is a period of the warming-up movement.

In the ink expelling control described above, the head adjustment section 8c causes each ink-jet head 30 to perform the ink ejecting process after the warming-up movement of the ink expelling apparatus 5 is ended. In FIG. 8, the period in which an ejection control signal JC1 is at a high level is a period in which each ink-jet head 30 is caused to perform the ink ejecting process.

The head adjustment section 8c causes the ink expelling apparatus 5 to perform the expelling movement, concurrently with the start of the ink ejecting process or following the start of the ink ejecting process. The head adjustment section 8c causes the ink expelling apparatus 5 to perform the expelling movement to thereby cause the ink expelling apparatus 5 to perform the ink expelling process.

In FIG. 8, the time point at which the valve control signal VD1 has changed from a low level to a high level is a time point at which the expelling movement has been performed. In the example illustrated in FIG. 8, the head adjustment section 8c causes the ink expelling apparatus 5 to perform the expelling movement, following the start of the ink ejecting process. The head adjustment section 8c causes the ink expelling apparatus 5 to perform the expelling movement to thereby cause the ink expelling apparatus 5 to perform the ink expelling process.

As illustrated in FIG. 8, when each ink-jet head 30 performs the ink ejecting process, the head pressure P1 is decreased by a degree necessary for the pressure-regulating-valve apparatus 42 to switch to the supply-path open state.

Therefore, when the ink expelling control is performed, the ink expelling process is started in a state in which ink can flow from the inflow port 42a to the outflow port 42b of the pressure-regulating-valve apparatus 42. As a result, the degree of decrease in head pressure P1 when the ink expelling process is started is mitigated (refer to FIG. 8).

The head adjustment section 8c further causes the ink-jet head 30 to stop the ink ejecting process, following the start of the ink expelling process. In FIG. 8, the time point at which the ejection control signal JC1 has changed from a high level to a low level is a time point at which the ink ejecting process is stopped.

The ink ejecting process is stopped immediately after the start of the ink expelling process, so that unnecessary power consumption by the plurality of piezoelectric elements 32 is avoided.

The ink ejecting apparatus 3 is adopted, so that the pressure-regulating-valve apparatus 42 can be prevented from being damaged due to the operation of the ink expelling apparatus 5.

### Modified Examples

The configuration of the ink ejecting apparatus 3 described above may be applied to another liquid ejecting apparatus that ejects liquid other than ink.

### Appendixes of Disclosure

A summary of the disclosure that is extracted from the embodiment described above is appended below. Note that configurations and processing functions that are described in appendixes described below may be selected to be combined discretionarily.

### Appendix 1

A liquid ejecting apparatus, including:

a liquid storage that stores therein liquid;

a liquid ejecting head that includes a plurality of nozzles, is supplied with the liquid from the liquid storage through a supply path, and is capable of performing a liquid ejecting process to eject liquid drops from each of the plurality of nozzles;

a pressure-regulating-valve apparatus that includes a valve capable of shutting off the supply path and temporarily switches from a certain state to another state according to a change in pressure caused in the supply path due to the liquid drops being ejected by the liquid ejecting head, the certain state being a state in which the supply path is shut off using the valve, the other state being a state in which the shutoff of the supply path using the valve is canceled;

a liquid expelling apparatus that includes a cap capable of covering the plurality of nozzles, and is capable of performing a liquid expelling process to expel the liquid from the liquid ejecting head through the cap by sucking in air from the cap covering the plurality of nozzles; and

a control apparatus that causes the liquid ejecting head to perform the liquid ejecting process according to occurrence of a liquid expelling event and causes the liquid expelling apparatus to perform the liquid expelling process, concurrently with start of the liquid ejecting process or following the start of the liquid ejecting process.

### Appendix 2

The liquid ejecting apparatus according to appendix 1, in which the control apparatus causes the liquid ejecting head to stop the liquid ejecting process, following the start of the liquid ejecting process.

### Appendix 3

The liquid ejecting apparatus according to appendix 1 or 2, in which

the liquid expelling apparatus includes
a suction pump,
an expelling path that communicates with an interior of the cap and with the suction pump,
a buffer tank that is arranged in the expelling path between the cap and the suction pump and temporarily stores therein air and the liquid that flow through the expelling path, and
a control valve that is arranged in the expelling path between the cap and the buffer tank and is capable of switching between an expelling-path closed state and an expelling-path open state according to an input control signal, the expelling-path closed state being a state in which the expelling path is shut off, the expelling-path open state being a state in which the shutoff of the expelling path being canceled, and

the liquid expelling apparatus performs the liquid expelling process by a warming-up movement and an expelling movement, the warming-up movement being a movement to operate and further stop the suction pump when the control valve is in the expelling-path closed state, the expelling movement being a movement to switch the control valve from the expelling-path closed state to the expelling-path open state after the warming-up movement is performed.

### Appendix 4

The liquid ejecting apparatus according to any one of appendices 1 to 3, in which

the pressure-regulating-valve apparatus includes
a primary chamber that includes an inflow port into which the liquid flows,
a secondary chamber that includes an outflow port from which the liquid flows, and includes an opening,
a cover member that covers the opening and includes a diaphragm that contracts and expands according to a change in pressure in the secondary chamber, and
the valve that opens and closes a communication hole according to the contraction and expansion of the diaphragm, the communication hole being formed in a partition between the primary chamber and the secondary chamber.

### Appendix 5

An ink-jet recording apparatus, including:

a sheet transportation apparatus that transports a sheet; and

the liquid ejecting apparatus according to any one of appendices 1 to 4, the liquid ejecting apparatus ejecting ink drops onto the transported sheet to form an image on the sheet.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. A liquid ejecting apparatus, comprising:
a liquid storage that stores therein liquid;
a liquid ejecting head that includes a plurality of nozzles, is supplied with the liquid from the liquid storage through a supply path, and is capable of performing a liquid ejecting process to eject liquid drops from each of the plurality of nozzles;
a pressure-regulating-valve apparatus that includes a valve capable of shutting off the supply path and temporarily switches from a certain state to another state according to a change in pressure caused in the supply path due to the liquid drops being ejected by the liquid ejecting head, the certain state being a state in which the supply path is shut off using the valve, the other state being a state in which the shutoff of the supply path using the valve is canceled;
a liquid expelling apparatus that includes a cap capable of covering the plurality of nozzles, and is capable of performing a liquid expelling process to expel the liquid from the liquid ejecting head through the cap by sucking in air from the cap covering the plurality of nozzles; and
a control apparatus that causes the liquid ejecting head to perform the liquid ejecting process according to occurrence of a liquid expelling event and causes the liquid expelling apparatus to perform the liquid expelling process, concurrently with start of the liquid ejecting process or following the start of the liquid ejecting process.

2. The liquid ejecting apparatus according to claim 1, wherein
the control apparatus causes the liquid ejecting head to stop the liquid ejecting process, following the start of the liquid ejecting process.

3. The liquid ejecting apparatus according to claim 1, wherein
the liquid expelling apparatus includes
a suction pump,
an expelling path that communicates with an interior of the cap and with the suction pump,
a buffer tank that is arranged in the expelling path between the cap and the suction pump and temporarily stores therein air and the liquid that flow through the expelling path, and
a control valve that is arranged in the expelling path between the cap and the buffer tank and is capable of switching between an expelling-path closed state and an expelling-path open state according to an input control signal, the expelling-path closed state being a state in which the expelling path is shut off, the expelling-path open state being a state in which the shutoff of the expelling path being canceled, and
the liquid expelling apparatus performs the liquid expelling process by a warming-up movement and an expelling movement, the warming-up movement being a movement to operate and further stop the suction pump when the control valve is in the expelling-path closed state, the expelling movement being a movement to switch the control valve from the expelling-path closed state to the expelling-path open state after the warming-up movement is performed.

4. The liquid ejecting apparatus according to claim 1, wherein
the pressure-regulating-valve apparatus includes
a primary chamber that includes an inflow port into which the liquid flows,
a secondary chamber that includes an outflow port from which the liquid flows, and includes an opening,
a cover member that covers the opening and includes a diaphragm that contracts and expands according to a change in pressure in the secondary chamber, and
the valve that opens and closes a communication hole according to the contraction and expansion of the diaphragm, the communication hole being formed in a partition between the primary chamber and the secondary chamber.

5. An ink-jet recording apparatus, comprising:
a sheet transportation apparatus that transports a sheet; and
the liquid ejecting apparatus according to claim 1, the liquid ejecting apparatus ejecting ink drops onto the transported sheet to form an image on the sheet.
